(19) United States
(12) Patent Application Publication
(10) Pub. No.: US 2002/0178036 A1
(43) Pub. Date: Nov. 28, 2002

(54) Project management method and project management system

(75) Inventors: Daijiro Murata, Tokyo (JP); Chiaki Hirai, Tokyo (JP); Yutaka Kudo, Tokyo (JP); Yuji Inoya, Tokyo (JP); Atsushi Mitomi, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/025,121

(22) Filed: Dec. 18, 2001

(30) Foreign Application Priority Data
May 23, 2001 (JP) 2001-153983

(51) Int. Cl. G06F 17/60

(52) U.S. Cl. 705/7

(57) ABSTRACT

A method of managing a hierarchically structured project on a computer. The method defines each of subprojects composing the hierarchical structure, define each structure of the works composing each subproject, stores information about each work of the subproject, collects informations about the corresponding works among the subprojects selected by the user as a compound work, and displays the information about the work on the compound-work basis.

### BACKGROUND OF THE INVENTION

1. Field of the Invention

The present invention relates to a project management system which is arranged to manage a plurality of projects in an integrated manner. More particularly, the present invention relates to the project management system which is arranged to manage the projects on the screen where displayed are the integrated working informations managed by a plurality of projects.

2. Description of the Related Art

One of the related arts with the project management method and system arranged to display on screen the working informations managed by the projects has been described in JP-A-2000-200308. In this related art, a plurality of WBS's (Work Breakdown Structure), each of which corresponds to a hierarchical structure displaying broken piece of the work of one project, are defined according to the sections concerned with the project and one WBS selected by the user of the system is displayed on screen.

For example, consider the case that when one developing system is divided into a plurality of subsystems and each subsystem is entrusted to another company or another section, the entrusting source would like to collectively display on screen the progress status of the entrusted projects. In a case that the entrusting source would like to use the integration of the projects as a view, disadvantageously, the foregoing related art has a shortcoming that a plurality of projects are not allowed to be integrated as one view on screen because the relation among the broken projects is obscure.

Moreover, the foregoing related art has a little limitation of referencing a project and a document. It is thus weak in security.

### SUMMARY OF THE INVENTION

It is an object of the present invention to provide a project management method and system which provide a capability of display on screen informations of projects having works related with each other in an integrated manner.

It is another object of the present invention to provide a project management method and system which provide a capability of displaying a hierarchical structure composed of only a project, a work and a document to be accessed by a user.

In carrying out the object in a preferred mode, a method of managing hierarchically structured project on a computer comprises the steps of defining subprojects composing the hierarchical structure; defining each structure of works composing each of the subprojects; storing information about each work of the subproject, collecting information about the works of the subprojects selected by the user as a compound work; and displaying the work information on a compound-work basis.

Further, the foregoing project management method is arranged to assign an access privilege to the project, the subproject and the work and then to display only the information of the project, the subproject and the work whose access privilege is possessed by the user.

### BRIEF DESCRIPTION OF THE DRAWINGS

FIG. 1 is a block diagram showing a schematic arrangement of a project management system according to a first embodiment of the invention;

FIG. 2 is a diagram showing an example of a WBS of the project;

FIG. 3 is a table showing an example of a project relation defining table 111 included in the first embodiment;

FIG. 4 is a table showing an example of a work definition table 112 included in the first embodiment;

FIG. 5 is a table showing an example of a work relation definition table 113 included in the first embodiment;

FIG. 6 is a table showing an example of a compound WBS definition table 114 included in the first embodiment;

FIG. 7 is a table showing an example of a document registration table 115 included in the first embodiment;

FIG. 8 is a table showing an example of a compound WBS document definition table 116 included in the first embodiment;

FIG. 9 is a view showing an example of a low level project creation screen included in the first embodiment;

FIG. 10 is a view showing an example of a project information display screen on which project information is displayed in an integrated manner included in the first embodiment;

FIG. 11 is a flowchart showing a procedure of a low level project creating unit 121 included in the first embodiment;

FIG. 12 is a flowchart showing a procedure of a display project determining unit 123 included in the first embodiment;

FIG. 13 is a flowchart showing a procedure of a WBS composing unit 124 included in the first embodiment;

FIG. 14 is a block diagram showing a schematic arrangement of a project management system according to a second embodiment of the invention;

FIG. 15 is a table showing an example of a project access privilege definition table 1411 included in the second embodiment;

FIG. 16 is a table showing an example of a work access privilege definition table 1412 included in the second embodiment;

FIG. 17 is a table showing an example of a document access privilege definition table 1413 included in the second embodiment;

FIG. 18 is a view showing an example of a low level projection creation screen included in the second embodiment;

FIG. 19 is a view showing an example of a project information display screen included in the second embodiment;

FIG. 20 is a flowchart showing a procedure of a low level project creating unit 1421 included in the second embodiment;

FIG. 21 is a flowchart showing a procedure of a display project determining unit 1423 included in the second embodiment; and

FIG. 22 is a flowchart showing a procedure of a WBS composing unit 1424 included in the second embodiment.

### DETAILED DESCRIPTION OF THE EMBODIMENT

1. First Embodiment

(1) Structure of Project

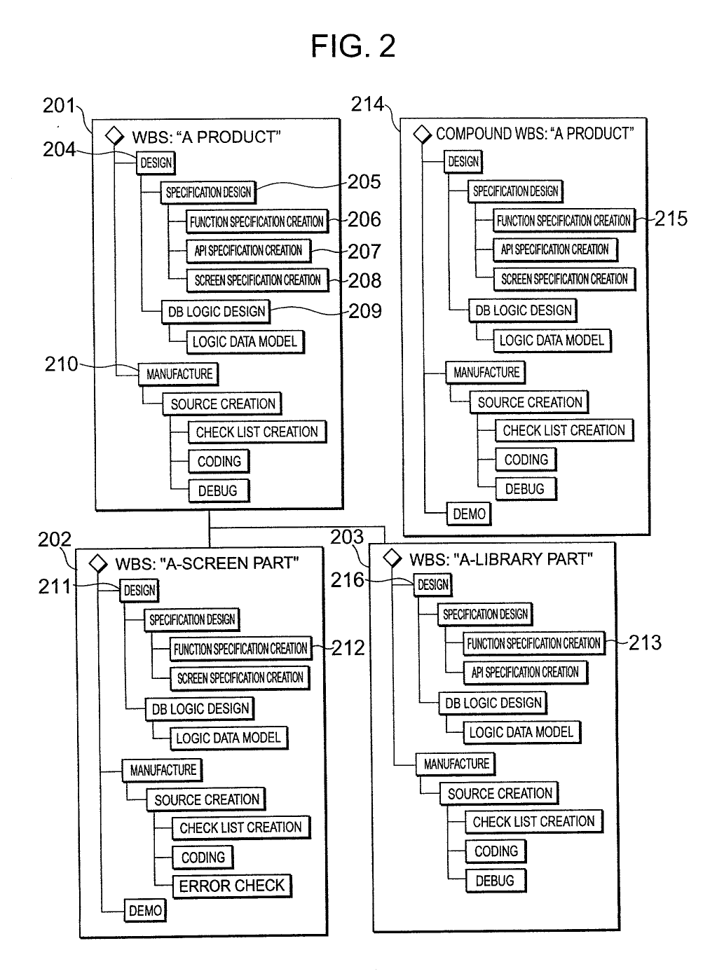

The description will be oriented to an example of the structure of a project to be managed with reference to FIG. 2. The project is represented in the form of the WBS (Work Breakdown Structure).

FIG. 2 illustrates an example of the WBS of the project in this embodiment. A numeral 201 denotes a WBS of a project of “A product”. The work of the “A product” project is broken up into a “design” work 204 and a “manufacture” work 210. The “design” work 204 is further broken up into a “specification design” work 205 and a “DB logic design” work 209. The “specification design” work 205 is further broken up into a “function specification creation” work 206, an “API specification creation” work 207, and a “screen specification creation” work 208.

The broken up work piece is called a low level work. The original work to be broken up is called a high level work, if viewed from the low level work. The “function specification creation” work 206 is the low level work of the “specification design” work 205. In the WBS 201 of the “A product” project, the “design” work 204 is the first stage of the work. The “specification design” work 205 is the second stage of the work. The “function specification creation” work 206 is the third stage work.

Assume that an “A-screen part” project and an “A-library part” project are derived from the “A product” project. In this case, the “A-screen part” project and the “A-library part” project are called the low level project of the “A product” project. The “A product” project is called the high level project of the “A-screen part” project and the “A-library part” project. The project that does not correspond to the low level one to any project is called the highest level project. In this case, the “A product” project is the highest level project.

A set of all projects to be reached sequentially in the trace of the low level project to the lowest level project as to a certain project A is called a low level project group. On the other hand, a set of all projects to be reached sequentially in the trace of the high level project of a certain project to the highest level project is called a high level project group. Further, a set of all projects to be reached sequentially in the trace of the low level projects and the high level projects of a certain project is called a project family.

When the work of the low level project is the work derived from the work of the high level project, in many cases, the work of the low level project is related with the work of the high level project. The work of the related high level project is called an upper master work of the work of the low level project. In this embodiment, the “function specification creation” work 206 of the “A product” corresponds to the upper master work of the “function specification creation” work 212 of the “A-screen part”.

The work that does not have any upper master work, obtained by sequentially tracking the upper master works of a certain work in the upward direction, called the uppermost master work of the certain work. In this embodiment, the “function specification creation” work 206 of “A product” is served as the uppermost master work of the “function specification creation” work 212 of the “A-screen part”.

Some processes such averaging, summing and integrating are performed with respect to the attribute informations of the related works such as their progress degree, schedule and persons in charge, for creating the attribute information of the compound one of the related works and collecting the related works. The collection of these works is called as a compound work. The combination or the integration of the WBS's of the related projects by composing the works is called a compound WBS.

The compound WBS 214 is a combination of the WBS 201 of the “A product” project, the WBS 202 of the “A-screen part” project, and the WBS 203 of the “A-library part” project. In the compound WBS 214, the “function specification creation” compound work 215 of the compound WBS 214 is a compound work of the “function specification creation” work 206 of the “A product” project, the “function specification creation” work 22 of the “A-screen part” project, and the “function specification creation” work 213 of the “A-library part” project.

In this embodiment, two low level projects are provided. In place, assume that ten low level projects are provided and are entrusted to three different companies X, Y and Z. The management of the compound WBS of the project related with the X company makes it possible to manage the whole progress of the X company, for example, whether or not the specification design is progressed as scheduled. It goes without saying that the creation of the compound BS of all projects is made possible.

(2) Arrangement of System

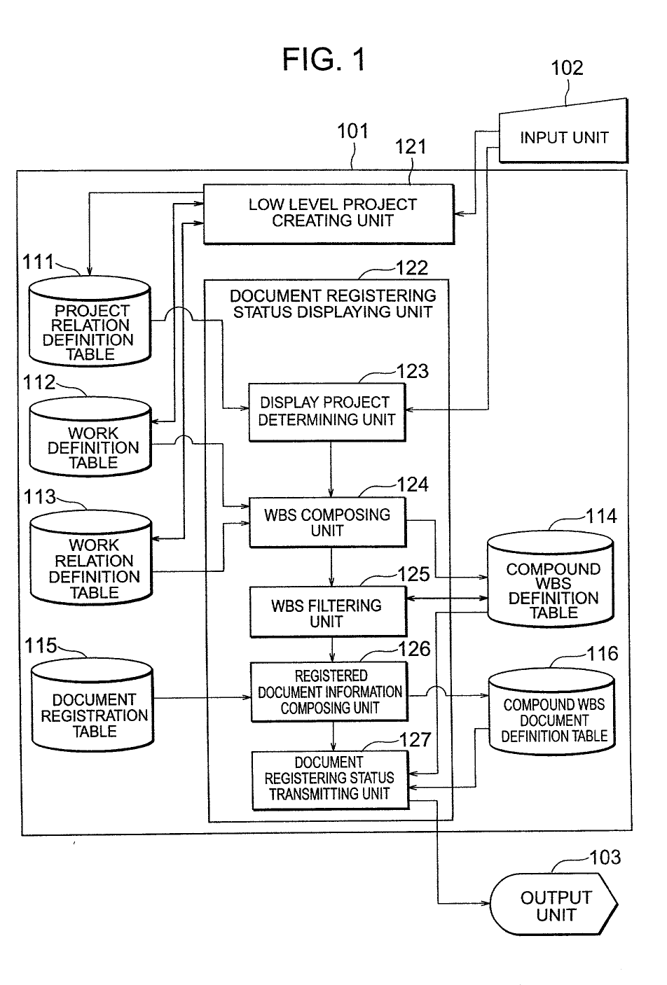

FIG. 1 illustrates a schematic arrangement of a project management system according to this embodiment.

In FIG. 1, a computer 101 provides an input unit 102 such as a keyboard or a mouse and an output unit 103 such as a display or a printer. The computer 101 includes a main storage unit for storing a software program, a CPU for executing the program and an external storage unit for storing tables.

Further, the computer 101 may provide a communication interface through which the computer 101 is connected with a network like the internet. The computer 101 is connected with another computer that is creating a document of each project through the network.

The main storage unit of the computer 101 includes a low level project creating unit 121 and a document registering status displaying unit 122. The document registering status displaying unit 122 is composed of a display project determining unit 123 for accepting a name of a reference project for specifying a set of projects to be displayed by the input unit 102 and a relation of another target project with the reference project and determining a plurality of projects to be displayed, a WBS composing unit 124 for composing the WBS's of the projects as a compound WBS by combining the related works as the compound work, a WBS filtering unit 125 for deleting the inappropriate work accepted by the input unit 102 from the compound WBS, the inappropriate work meaning the work that is not matched to the display condition, a registered document information composing unit 126 for registering a document and its information registered in the work of each project in the compound work, and a document registering status transmitting unit 127 for transmitting the document registering information of the compound WBS and the compound work to the output unit 103.

These processing units are executed by the software programs, which are read out of the main storage unit and then are executed by the CPU. These software programs may be stored in a storage unit such as a CD-ROM or a magnetic disk or distributed through the network.

The external storage unit of the computer 101 includes a project relation definition table 111 for defining a derivative relation among the projects, a work definition table 112 for defining the attribute information of the work of each project such as a progress degree, a schedule and a person in charge and the tree structure of the WBS, a work relation definition table 113 for defining the work of the source deriving project corresponding with the work of the derived project from the source project, a document registration table 115 for defining the information of the registered document to the work of each project, and a compound WBS document definition table 116 for defining the document registration information of the compound work. The flow of the processes and those tables will be described later in detail.

(3) Definition and Registration of Project

The description will be oriented to the procedure of defining the project to be managed and registering the defined project in the project management system. \mathring{1} Definition of Work Structure

A user (often, a system manager) operates to define as a WBS the structure of the basic work having the projects composed in the manner denoted by 201 of FIG. 2. \mathring{2} Definition of Highest Level Project

The user defines an identification (ID) name of the highest level project and the work structure of the project through the use of the work structure defined by (1).

The definitions (1) and (2) are executed through the software programs and are stored as a record range 411 of the work definition table 112 (to be discussed later). \mathring{3} Definition of Low Level Project

The user defines and registers the lower level project than the highest level project through the use of the low level project creating unit 121.

In turn, the description will be oriented to the structure of the table created and updated by the low level project creating unit 121.

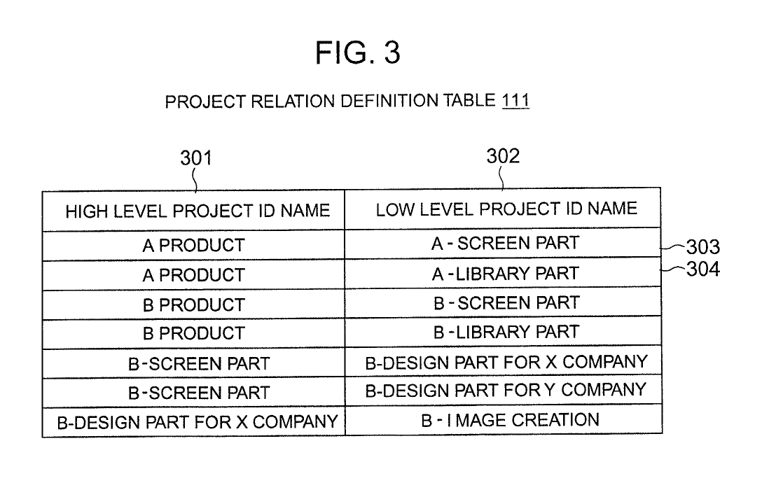

FIG. 3 illustrates an example of the project relation definition table 111. In FIG. 3, a high level project ID name 301 is an ID name for identifying a project. A low level project ID name 302 is an ID name for identifying a low level project belonging to the high level project to be identified by the high level project ID name 301. A row composed of the high level project ID name 301 and the low level project ID name 302 composes a record for representing a relation between one high level project and one low level project in the project relation definition table 111.

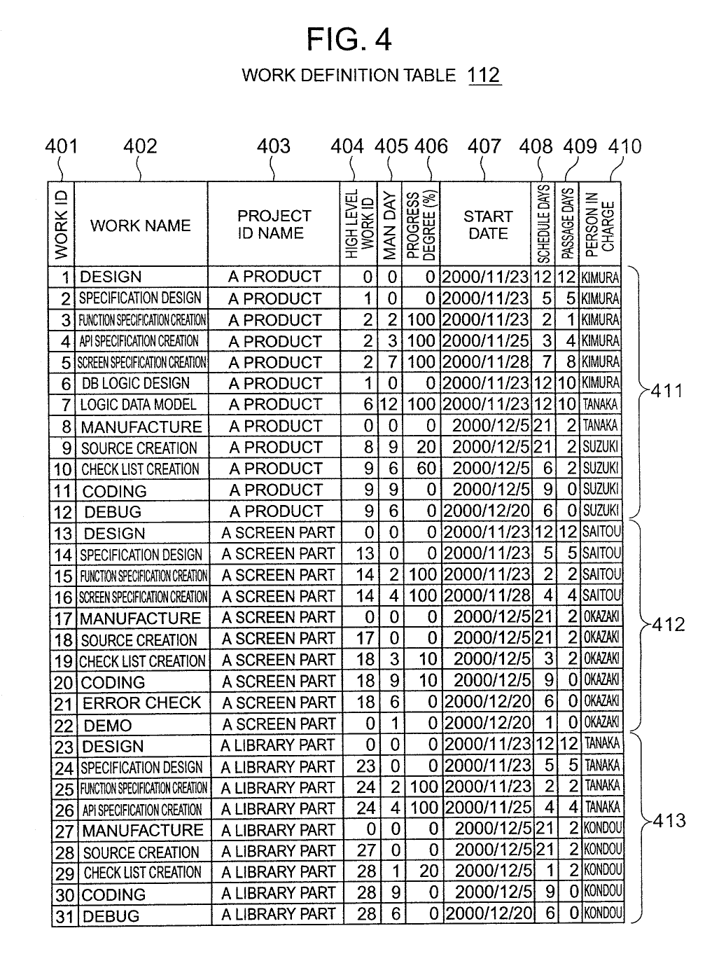

FIG. 4 illustrates an example of the work definition table 112 included in this embodiment. In FIG. 4, a work ID 401 denotes an ID for identifying a work. A work name 402 is a name of a work to be identified by the work ID 401. A project ID name 403 is an ID name of the project having a WBS composed by the work to be identified by the work ID 401.

Further, the high level work ID 404 is a work ID of the high level work of the work to be identified by the work ID 401. The high level work ID 404 of the work where the high level work does not exist is “0”. Moreover, a man-day 405 denotes a value derived by multiplying the number of workers required for setting the work to be identified by the work ID 401 by the number of days required therefor.

A progress degree 406 is a value for representing a progress degree as to how much of the work is executed when the workload to be performed by the work is assumed to be “100”. A start date 407 is a day, month and year when the work is to be started. A schedule day 408 is the number of days to be scheduled to the execution of the work. A passage day 409 is the number of days passed in performing the work. A person name 410 is the name of a person in charge of the work. A row composed of the items from the work ID 401 to the person name 410 composes a record for representing one work in the work definition table 112.

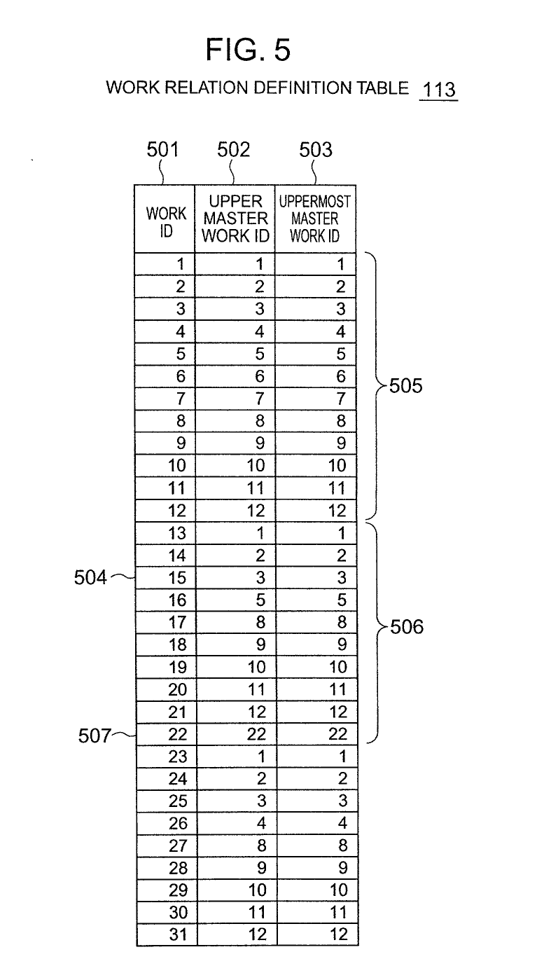

FIG. 5 illustrates an example of the work relation definition table 113 included in this embodiment. In FIG. 5, the work ID 501 is an ID for identifying the work. For the same word, the work ID 401 of the work definition table 112 has the same value as the work ID 501 of this table 113.

An upper master work ID 502 is an ID of the upper master work of the work to be identified by the work ID 501. The uppermost master work ID 503 is an ID of the uppermost master work. For the uppermost master work, the work ID=the upper master work ID=the uppermost master work ID is given. A row composed of the items from the work ID 501 to the uppermost master work ID 503 composes a corresponding relation of one work in the work relation definition table 113.

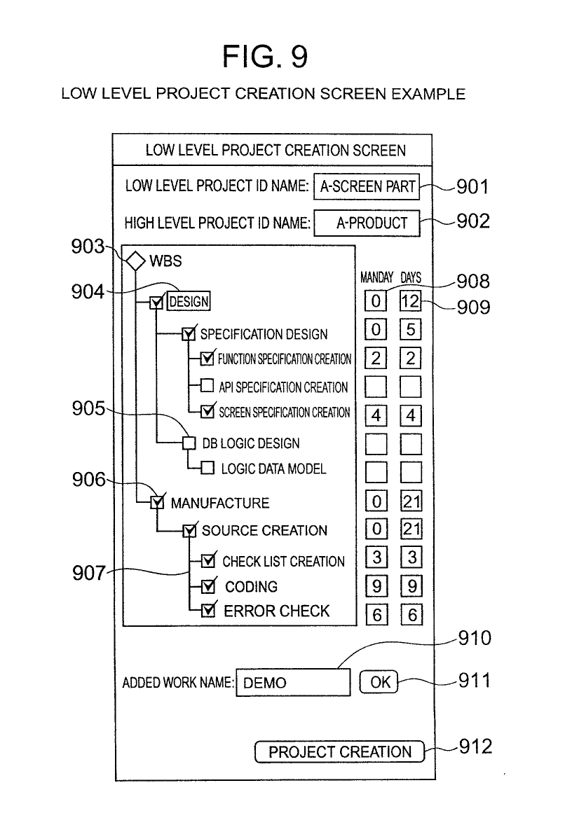

When the low level project creating unit 121 is started by the user, the screen shown in FIG. 9 is displayed.

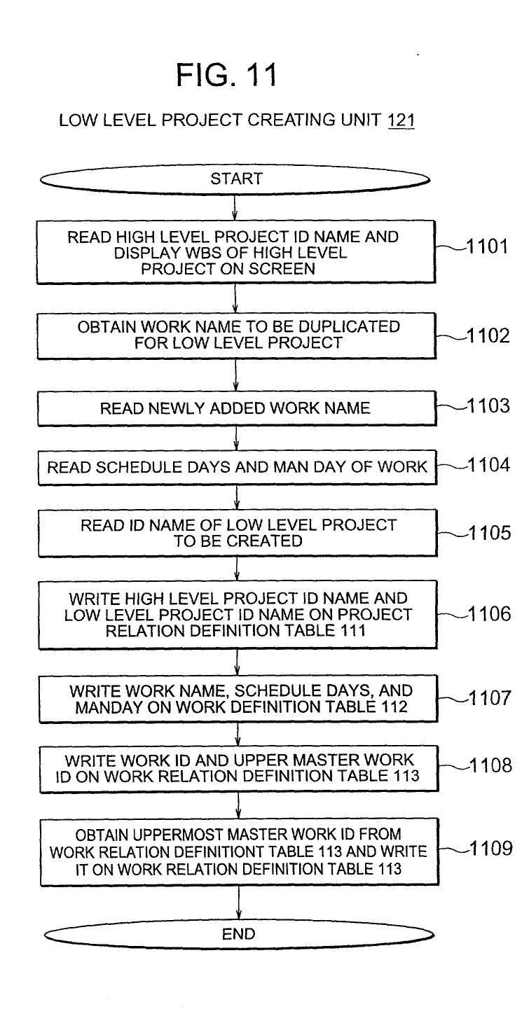

FIG. 11 is a flowchart showing a procedure of the low level project creating unit 121 included in this embodiment. At first, the user enters a project ID name into a high level project ID name entry column 902 for selecting the high level project as the derivative source of the subproject to be created. When the high level project ID name is entered, the low level project creating unit 121 is served to read the high level project ID name and then display the WBS of the high level project (step 1101). In the embodiment shown in FIG. 9, the high level project ID name “A product” is read out of the high level project ID name entry column 902. Then, the WBS of the “A product” project is created from the record in the range 411 of the work definition table 112 and then is displayed on a WBS display unit 903.

Then, the user enters the settings of the low level project to be created on the low level project creation screen by using the WBS of the high level project. In the embodiment shown in FIG. 9, all low level works of the “design” work, the “specification design” work, the “function specification creation” work, the “screen specification creation” work, and the “manufacture” work are selected as the works to be duplicated into the low level project. Moreover, the user defines the workload of each selected work by entering the man-day and the schedule days on a man-day entry column 908 and a days entry column 909. As an example, the man-day of the “design” work is 0 man-day and the schedule days thereof is 12 days.

In a case that a unique work to the derived project is executed in the derivative source, the user enters a work name on an additional work name entry column 910 and then clicks an OK button 911. In the embodiment shown in FIG. 9, the derived project “A-screen part” is served to manage the work named “Demo” that is not in the derivative source project “A product”. When the user clicks the OK button 911, the work name “Demo” is added to the lowest row of the first stage of the WBS displayed on the WBS display unit 903, concretely, under the “error check” of the screen shown in FIG. 9. If the user would like to change the location of the added work on the WBS, the added work name is dragged on the screen to the proper location.

Next, the user enters the ID name of the low level project to be created. In the embodiment shown in FIG. 9, the user enters the “A-screen part” as the name of the low level project to be newly created.

After the settings of the low level project to be created in the aforementioned manner are entered, the user clicks a project creating button 912. Then, the low level project creating unit 121 is served to read the entered settings of the low level project on the main storage unit. At first, the low level project creating unit 121 is served to read the settings as to which work of the high level project is duplicated in the low level project and then to store them on the main storage unit (step 1102). In the embodiment shown in FIG. 9, the name of the work to be duplicated is stored on the main storage unit.

Then, the operation is executed to read the work name to be newly added and then store it on the main storage unit (step 1103). In FIG. 9, the work name “Demo” to be added is read.

Next, the operation is executed to read the man-day and the schedule days of each work of the low level project and then to store them on the main storage unit (step 1104). In FIG. 9, the man-day and the schedule days of each work are read from the man-day entry column 908 and the schedule days entry column 909.

Next, the operation is executed to read the project ID name of the low level project to be created and then store it on the main storage unit (step 1105). In FIG. 9, the low level project ID name “A-screen part” is read from the low level project ID name entry column 901.

Next, the low level project creating unit 121 is served to write in an external storage unit the information of the low level project to be created, read on the main storage unit at the steps 1102 to 1105. At first, the low level project ID name 301 read at the step 1101 and the low level project ID name 302 read at the step 1105 are written on the project relation definition table 111 (step 1106). In this embodiment, the high level project ID name “A product” and the low level project ID name “A-screen part” are written on the record 303.

Next, the work name 402 read at the step 1103 and the man-day 405 and the schedule days read at the step 1104 are written on the work definition table 112. At a time, the work ID 401 defined as the sequential number values on the column and the high level work ID 404 derived from the vertical relation of the work of the high level project are written on the work definition table 112 together with the work name 402, the man-day 405 and the schedule days 408 (step 1107). In this embodiment, the record about the “A-screen part” project is written on the row in the range 412 of the work definition table 112.

Next, the work ID 501 and the upper master work ID 502 of the low level project to be created are written on the work relation definition table 113 (step 1108). In this embodiment, the same value as the work ID 401 written at the step 1107 is written as the work ID 501 of the project “A-screen part” in the range 506 of the work relation definition table 113. Further, the ID of the work belonging to the high level project “A product” of the project “A-screen part” is written as the upper master work ID 502. Moreover, the upper master work of the work “Demo” to be newly added to the project “A-screen part” is the work “Demo” itself. Hence, the value “22” is written as the work ID 501 and the upper master work ID 502 on the row 507.

After the relation between the work and the upper master work is written, the operation is executed to obtain the uppermost master work ID 503 from the work relation definition table 113 and write it on the work relation definition table 113 (step 1109). In this embodiment, the operation is executed to obtain the uppermost master work ID 503 of the “A-screen part” project from the record in the range 505 of the project “A product” and write it in the range 506 for representing the record of the project “A-screen part”. Further, the work ID “22” of this work “Demo” is written as the uppermost master mask ID of the row 507 for indicating the work “Demo”.

The foregoing processes executed by the low level project creating unit 121 make it possible for the low level project shown in FIG. 9 to manage the newly entrusted low project “A-screen part” through the use of the present system itself.

The user repeats the aforementioned registering operation about all low level projects.

(4) Report on Progress of Project

The manager or the person in charge of each project enters a progress status of the work in the system through the software program at the defined intervals. The entered data is stored as the progress degree 406 of the work definition table 112 (see FIG. 4). Further, the person in charge enters the location of the document being created or the completed document in the system through the software program. The entered data is stored in the document registration table 115.

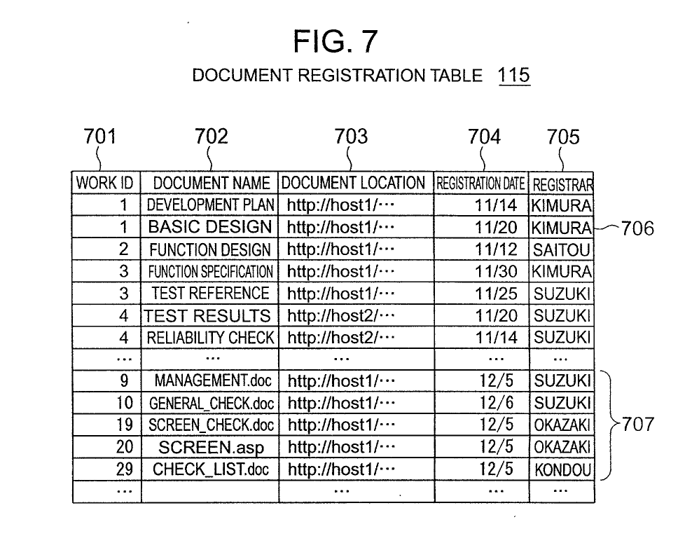

FIG. 7 illustrates an example of the document registration table 115. In FIG. 7, a work ID 701 is the ID of the work where the document is registered. A document name 702 is the name of the document registered in the work. A document location 703 is the URL (Uniform Resource Locators) for indicating the location of the document registered in the work. A registration date 704 is the date when the document is registered. A registrar name 705 is the name of the registrar who registered the document.

(5) Display of Project

The user of the project management system starts the document registering status displaying unit 122, so that the details and the progress of the project may be displayed.

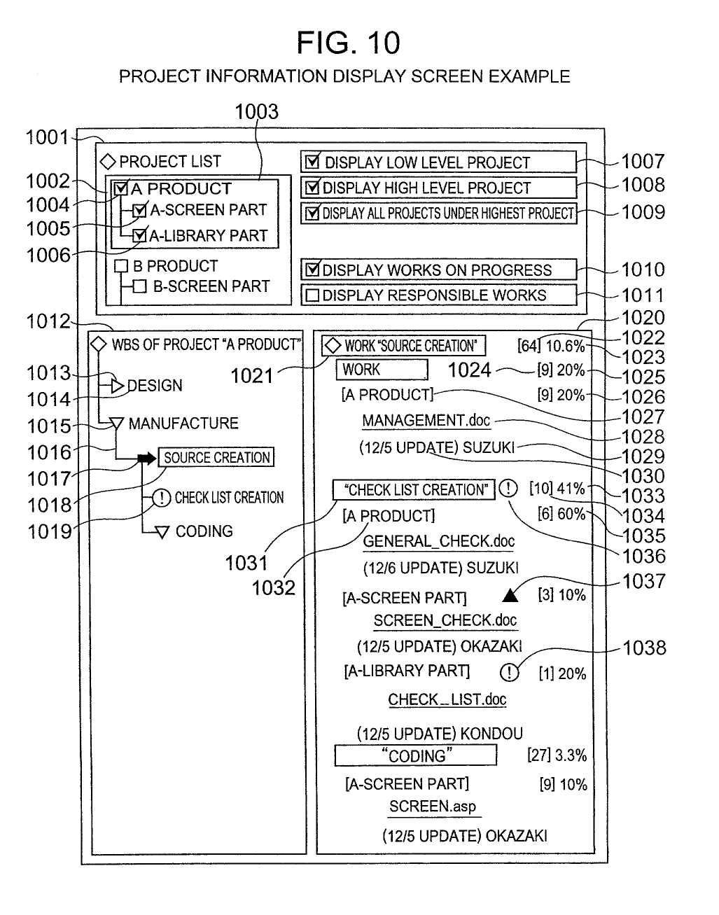

When the document registering status displaying unit 122 is started, as shown in FIG. 10, the project list and the display conditions are displayed in a box 1001. The user specifies one reference project to be displayed in the project list 1002 for specifying a set of projects to be displayed.

Next, the user sets the relation between the reference project and another project to be displayed by checking check boxes 1007 to 1009.

When the user clicks a display button (not shown), the control is shifted to the display project determining unit 123, when the lower portion 1012 of FIG. 10 is displayed.

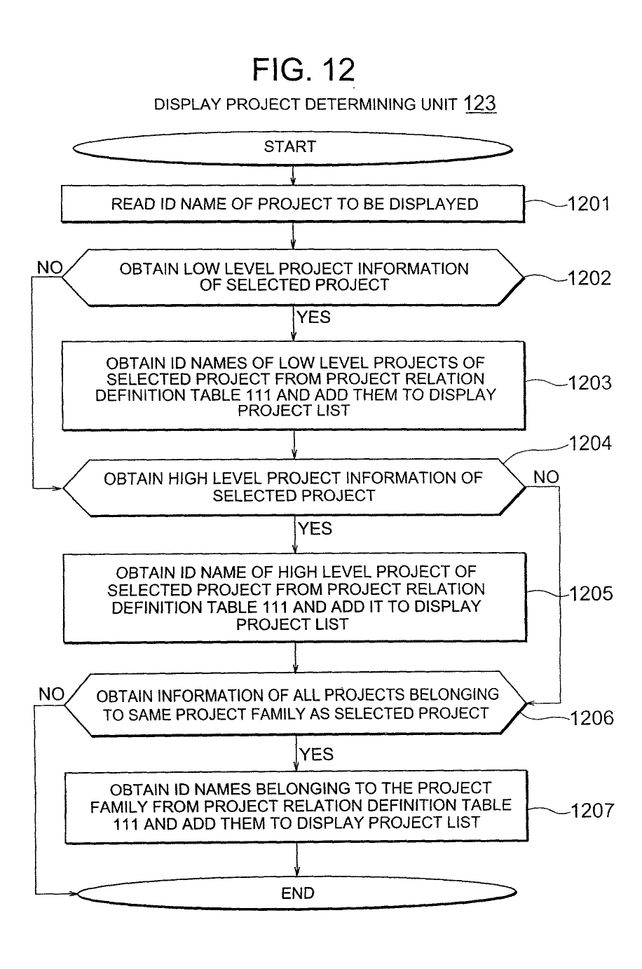

The procedure of the display project determining unit 123 will be described with reference to FIG. 12.

The determining unit 123 is served to read the ID name of the project specified in the box 1002 (step 1201).

The determining unit 123 is served to check if the low level project of the selected project is set to be displayed (step 1202). If the information of the low level project is set to be displayed, the project ID names of the low level project group of the selected project are sequentially obtained from the project relation definition table 111 (step 1203). In the embodiment shown in FIG. 10, since the check box “Low level project is displayed as well” 1007 is checked, the project ID name “A-screen part” and “A-library part” are obtained from the records 303 and 304 of the project relation definition table 111.

Then, the determining unit 123 is served to check if the information of the high level project group of the selected project is set to be displayed (step 1204). If set, the project ID names of the high level project group are sequentially obtained from the project relation definition table 111 (step 1205).

Next, the determining unit 123 is served to check if the information of all projects in a project family belonging to the selected project is set to be displayed (step 1206). If the information of all projects in the project family is set to be displayed, the project ID names of the project belonging to the project family are sequentially obtained from the project relation definition table 111 (step 1207).

The foregoing process makes it possible for the display project determining unit 123 to read the project ID names of all projects to be displayed in the main storage unit.

Then, the control is shifted to the WBS composing unit 124, in which the WBS of the specified project is composed.

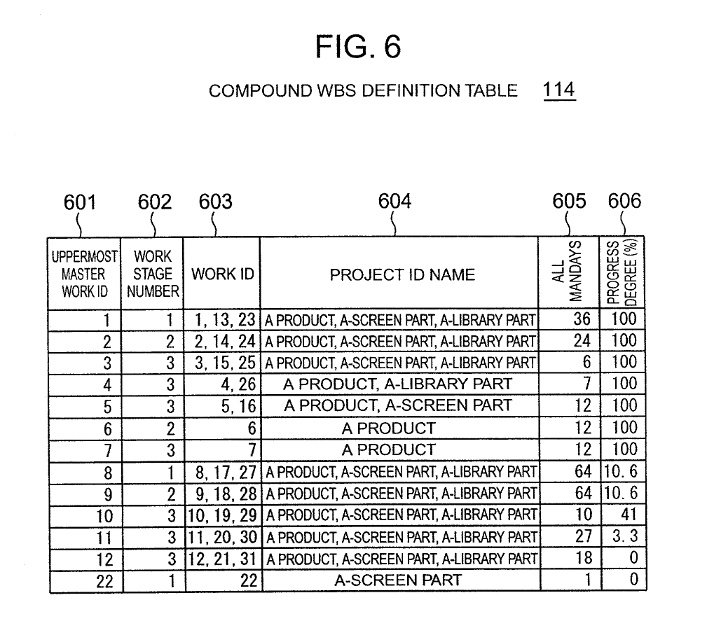

An example of the compound WBS definition table 114 temporarily created by the WBS composing unit 124 is illustrated in FIG. 6.

The uppermost master work ID 601 corresponds to the ID of the uppermost master work, functioned as an ID value of the compound work. The work stage number 602 corresponds to the stage number located in the compound WBS of the compound work.

All man-days 605 correspond to an added value of the man-day of the compound work uniquely shown by the uppermost master work ID 601 and the man-days of all compound works lower thereto. A progress degree 606 corresponds to the progress degree of the compound work, which is an average value derived by multiplying the progress degree of the works composing the compound work by the man-day and dividing the result by all man-days 605.

The ranging sequence of the compound works in the compound WBS is matched to the ranging sequence of the compound WBS definition table 114. One row composed of the items from the uppermost master work ID 601 to the progress degree 606 forms the record for representing one compound work in the compound WBS definition table 114.

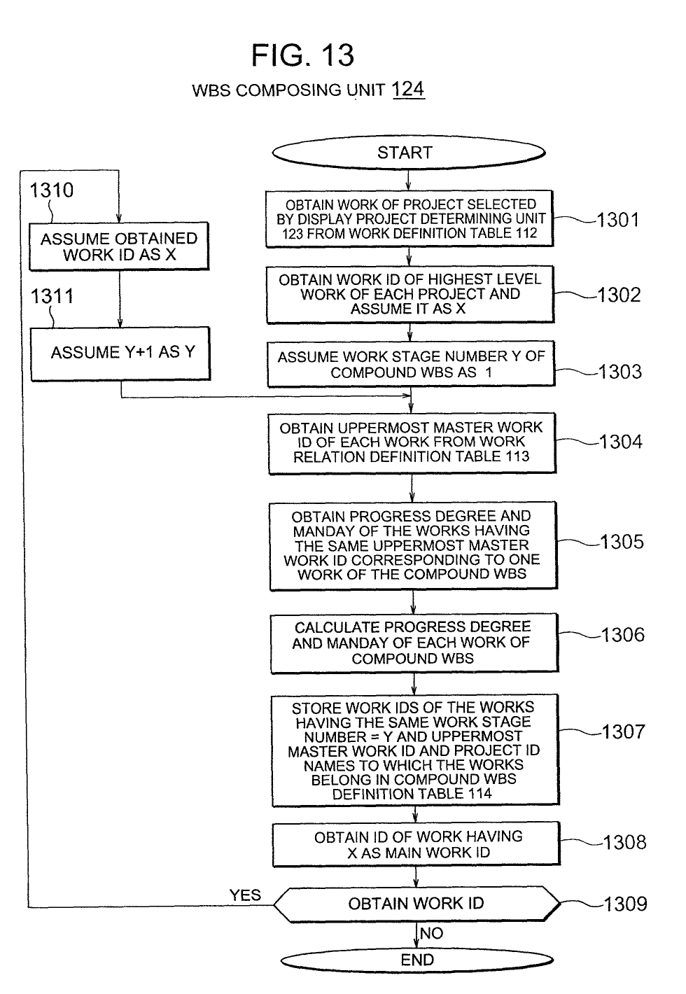

FIG. 13 is a flowchart showing a procedure of the WBS composing unit 124 included in this embodiment. At first, the work information of each project to be displayed, determined by the display project determining unit 123, is obtained from the work definition table 112 and then is stored on the main storage unit (step 1301).

Then, the WBS composing unit 124 is served to compose the first-stage work of the compound WBS. At first, the WBS composing unit 124 is served to obtain the work ID of the highest level work of each project from the work definition content of the work definition table 112 held on the main storage unit and substitute the value of the work ID in X for the purpose of selecting the source works to be composed (step 1302). In this embodiment, X is assigned to a set of the work IDs “1”, “13”, “23” and “8”, “17”, “27” of the first stage work “design”, “manufacture” and “Demo” of each project of “A product”, “A-screen part” and “A-library part”, and the work ID “22”. Further, a value of “1” is substituted in a variable Y for representing the number of work stages of the compound work to be created (step 1303).

Next, the attribute value of each source work to be composed is obtained. At first, the operation is executed to obtain the uppermost mater work ID of each work ID from the work relation definition table 113 (step 1304). Then, the operation is executed to obtain the progress degree and the man-day of the work having the same uppermost mater work ID corresponding to one compound work of the compound WBS (step 1305).

Then, the WBS composing unit 124 is served to calculate the attribute value of the compound work on the attribute value of each source work to be composed. In this embodiment, the operation is executed to obtain the progress degree and the man-day of each work of the compound WBS from the progress degree and the man-day of each work composing the compound work obtained at the step 1305 (step 1306). The calculating method is as follows. The multiplication of the progress degree of one work by the man-day thereof results in calculating the man-day heretofore attained by the work. The calculated man-days of all low level works are added to each other. The added result corresponds to the workload (men×days) heretofore attained by all relevant works of a certain work including its low level works. The division of the workload by the added values of the man-days of all relevant works including the low level works results in calculating the progress degree of the compound work. For example, all man-days of the “check list creation” compound work are “10”, the heretofore attained workload of all relevant works having the low level works is “4.1”, and the progress degree of the compound work is 41%.

The foregoing process results in having created the attribute information of the compound work. Then, the WBS composing unit 124 is served to store the information about the compound work in the compound WBS definition table 114. The work stage number, the work IDs of the works composing the compound work, and the ID name of the project to which the works belong are stored in the compound WBS definition table 114 (step 1307). The foregoing process results in having created the first stage work of the compound WBS.

Next, the second stage work of the compound WBS is composed. The operation is executed to obtain the work IDs of the low level works of the source work to be composed, included in the first stage compound work (step 1308). If any low level work is found (step 1309), the obtained work ID is substituted in X (step 1310) and the work stage number Y is incremented to 2 (step 1311). Then, the processes from the steps 1304 to 1308 are executed again. These processes result in storing the attribute information of the second stage compound work in the compound WBS definition table 114.

Until the lowest stage compound work is created, the processes from the steps 1304 to 1311 are repeated. After the calculation of each stage is executed in the same manner until it reaches the lowest stage, the calculated result of each stage is calculated sequentially from the lowest stage for obtaining the accumulated value of all stages from the lowest stage to the current stage. Then, the accumulated value is stored in the compound WBS definition table 114. The foregoing process results in having created the WBS of the specified projects.

Then, the control is shifted to the WBS filtering unit 125. The WBS filtering unit 125 is served to delete the work that is not matched to the display condition accepted from the input unit 102 from the compound WBS.

The WBS filtering unit 125 is served to compare each record of the compound WBS definition table 114 with the condition and to erase the record that is not matched to the condition. In the embodiment shown in FIG. 10, the check box 1010 is specified so that only the information of the work in progress may be displayed. Hence, the record with the progress degree “0” or “100” is erased from the compound WBS definition table 114. As a result, there are left only the records for representing the works of “manufacture”, “source creation”, “check list creation”, and “coding”. The foregoing processes result in having created the compound WBS displayed on the screen.

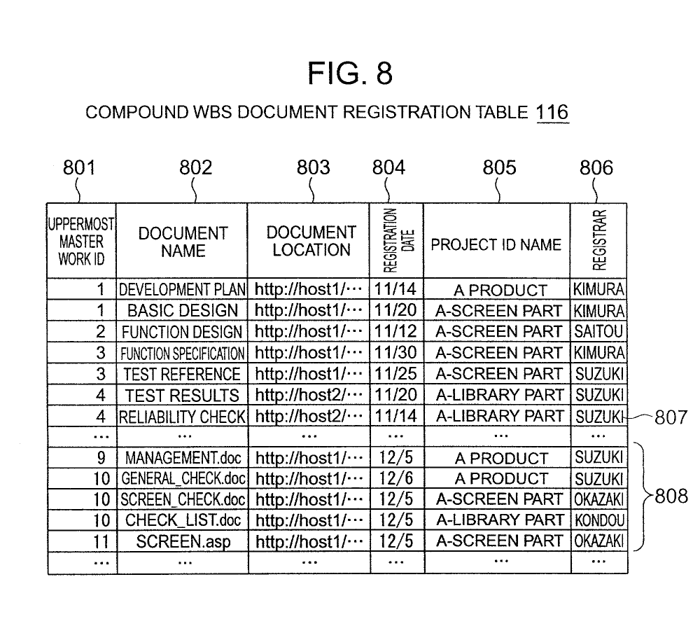

Then, the control is shifted to the registered document information composing unit 126. An example of the compound WBS document definition table 116 temporarily created by the composing unit 126 is illustrated in FIG. 8. An uppermost master work ID 801 is the uppermost master work ID of the compound work. A document name 802 is a name of a document registered in the compound work. A document location 803 is a URL for indicating the location of the document registered in the compound work. A registration date 804 is a date when the document is registered. A project ID name 805 is an ID name of a project where the document is registered. A registrar 806 is a name of a person who has registered the document.

A row composed of the items from the uppermost master work ID 801 to the registrar 806 forms a record for representing the information of a document registered in the compound work of the compound WBS in the compound WBS document definition table 116.

In turn, the detailed description will be oriented to the processing flow of the registered document information composing unit 126 for registering the information about the registered document of each work in the compound work.

At first, the operation is executed to obtain the uppermost master work ID and the work IDs of the works having the same upper master work ID from the compound WBS definition table 114.

Next, the operation is executed to obtain the document name, the location and the registration date of each work ID from the document registration table 115 and then to store them in the compound WBS document definition table 116 together with the uppermost master work ID. In the tables shown in FIGS. 7 and 8, the information of the document registered in each work of “manufacture”, “source creation”, “check list creation”, and “coding” of each project obtained from the record 707 is written in the record in the range 808 together with the uppermost master work ID.

The foregoing processes result in having created the compound WBS and its document registration information to be displayed. Then, a document registering status transmitting unit 127 is served to transmit the compound WBS and its document registration information to the output unit 103 and then to output them onto the screen.

The document registering status transmitting unit 127 is served to display the compound WBS registered in the compound WBS definition table 114 and the compound work document registration information registered in the compound WBS document definition table 116 on the output unit 103. In the embodiment shown in FIG. 10, the WBS's of the “A product” project, the “A-screen part” low level project, and the “A-library part” low level project are collectively displayed on the WBS display unit 1012.

Herein, a work name 1014 is the name of the work. Each of the buttons 1013, 1017 and 1019 represents the state of the work. The transmitting unit 127 is served to connect one work with another work by a work high-low level relation line 1016. As to the works not to be displayed by the check boxes 1010 and 1011, like the work name 1014, only the highest level work of the works not to be displayed is displayed or nothing is displayed. In the case of displaying only the highest level work, if the button 1013 is clicked, the low level work is displayed and the form of the work is changed in the form indicated by the button 1015.

When the work name 1018 is clicked, the attribute information of the selected work and the lower level works to that work and the registered document information are displayed on the work information display unit 1020. At this time, the button is transformed as an arrow like the button 1017. In FIG. 10, the “source creation” compound work is displayed in the work name 1018. The button 1019 represents the case that the “check list creation” work of any one of the projects “A product”, “A-screen part” and “A-library part” goes beyond the schedule days.

Within the work information display unit 1020 are displayed a work name 1021 of the selected compound work, all man-days 1022 and a progress degree 1023 of the work including the low level works, a man-day 1024 and a progress degree 1025 of the work excluding the low level works, a project name 1027 of the project to which the works composing the compound work belong, a man-day and a progress degree 1026 thereof, a document name 1028 thereof, a document registration date 1030 thereof, and a document registrar name 1029 thereof.

When the document name 1028 is clicked, the document is obtained from the URL for indicating the location of the document and then is displayed on another screen. At a time, on the screen are displayed a name 1031 of the low level compound work, a state display mark 1036, all man-days 1034, a progress degree 1033, a project name 1032 to which the works composing the low level compound work belong, and a man-day and a progress degree 1035.

A state display mark 1036 is transformed according to the value of the progress degree. It is transformed into a triangle as shown in a state display mark 1037 when the process is later than scheduled. If it goes beyond the due date, it is transformed into the mark as indicated by the state display mark 1038. In this example are displayed all man-days and progress degree of the “source creation” wok, all man-days and a progress degree of the “check list creation” low level work and “coding” low level work, and information about the registered document. In each project of the “A product”, the “A-screen part” and the “A-library part”, no information is displayed about the work not being currently progressed. Further, the “check list creation” work of the “A-screen part” project is later than scheduled. The “check list creation” work of the “A-library part” project goes beyond the schedule days.

The foregoing process terminates the operation of the document registering status displaying unit 122. This embodiment thus makes it possible for the user to display only the results of the operation in progress from all the informations of the entrusted projects and the entrusting source projects.

2. Second Embodiment

It is often requested to put limitations on access to the details of the project or the work or the registered document. In this embodiment, a privilege of access may be assigned to a person who would like to access the information. Hence, only the authorized person can access the information.

In the following, the different part of this embodiment from that of the first embodiment will be described.

(1) System Arrangement

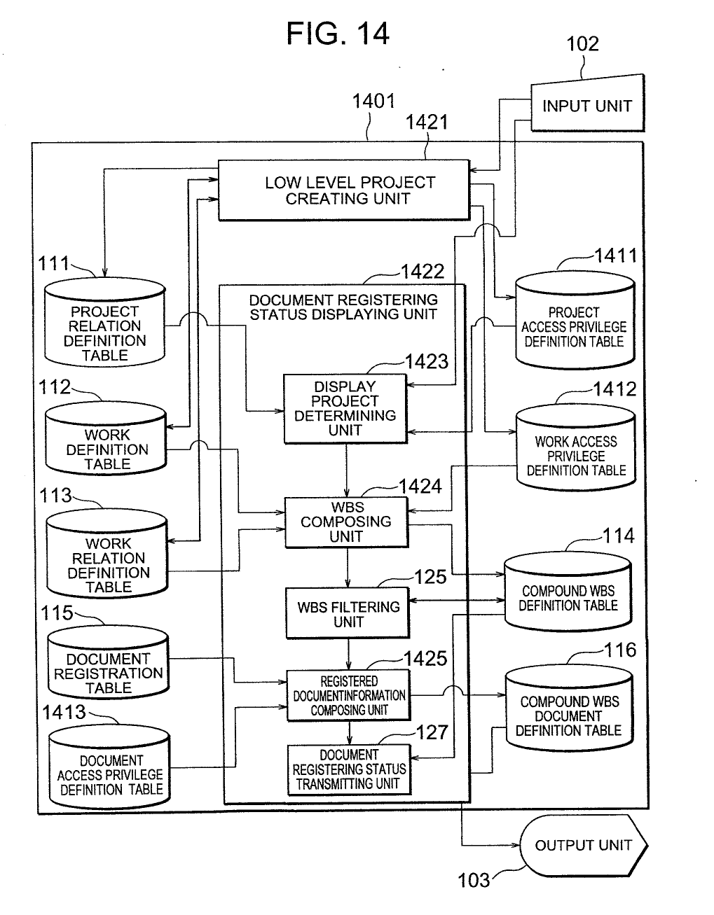

As shown in FIG. 14, the difference between the project management system of this embodiment and that of the first embodiment is parts of the processes of the low level project creating unit 1421, the document registering status displaying unit 1422, the display project determining unit 1423, the WBS composing unit 1422, and the registered document information composing unit 1425.

In addition to the processes of the first embodiment, the second embodiment includes a document access privilege definition table 1413, a project access privilege definition table 1411, and a work access privilege definition table 1414.

(2) Definition and Registration of Project

At first, the description will be oriented to the structure of the newly added tables in this embodiment.

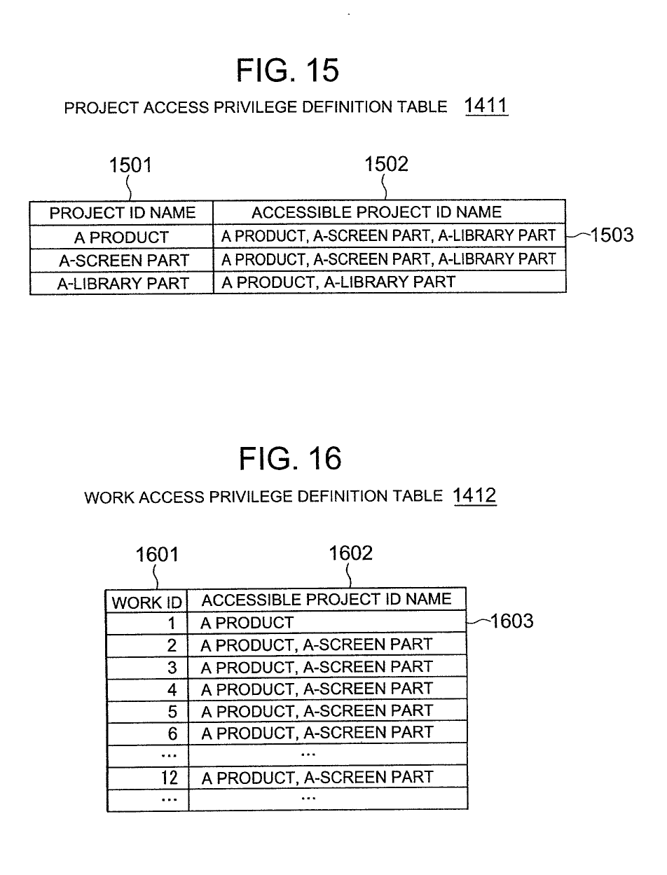

FIG. 15 illustrates an example of a project access privilege definition table 1411 according to this embodiment. In FIG. 15, a numeral 1501 denotes a project ID name. A numeral 1502 denotes an ID name of a project to which the user who can access the project specified by the ID name 1501 belongs. One row composed of the columns 1501 and 1502 forms a record for defining which of the projects allows its members to access a certain project. In FIG. 15, a row 1503 means that the user belonging to the “A product” project can access the informations of the “A-screen part” project and the “A-library part” project.

FIG. 16 illustrates an example of the work access privilege definition table 1412 of this embodiment. In FIG. 16, a numeral 1601 denotes a work ID. A numeral 1602 denotes an ID name of a project to which the user who can access the work specified by the work ID 1601 belongs. A row composed of columns 1601 and 1602 forms a record for defining which of projects allows its members to access a certain project. In FIG. 16, a row 1603 means that only the user belonging to the “A product” project can access the information of the work with a value of 1 as its work ID.

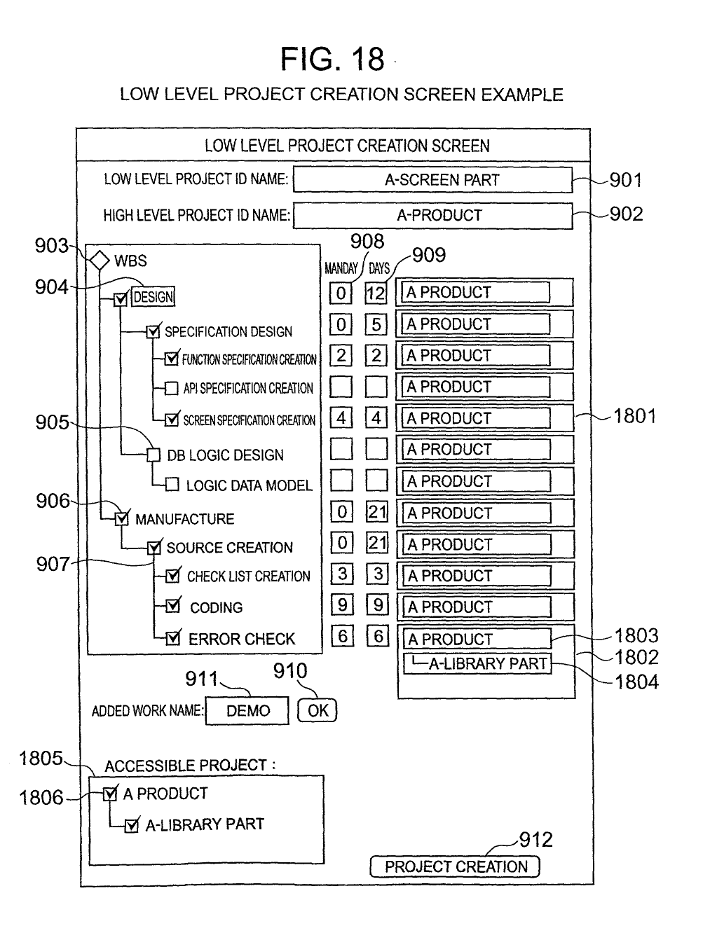

The low level project creating unit 1421 is served to display the screen as shown in FIG. 18.

In FIG. 18, the user can define which of the projects allows its members to access the project to be created through a project tree 1805.

The user checks a check box 1806 of the project that can access the low level projects for selecting the project to be accessed. Further, the user defines which of the projects allows its members to access the work to be created on a work access privilege setting column 1801 adjacent to the work.

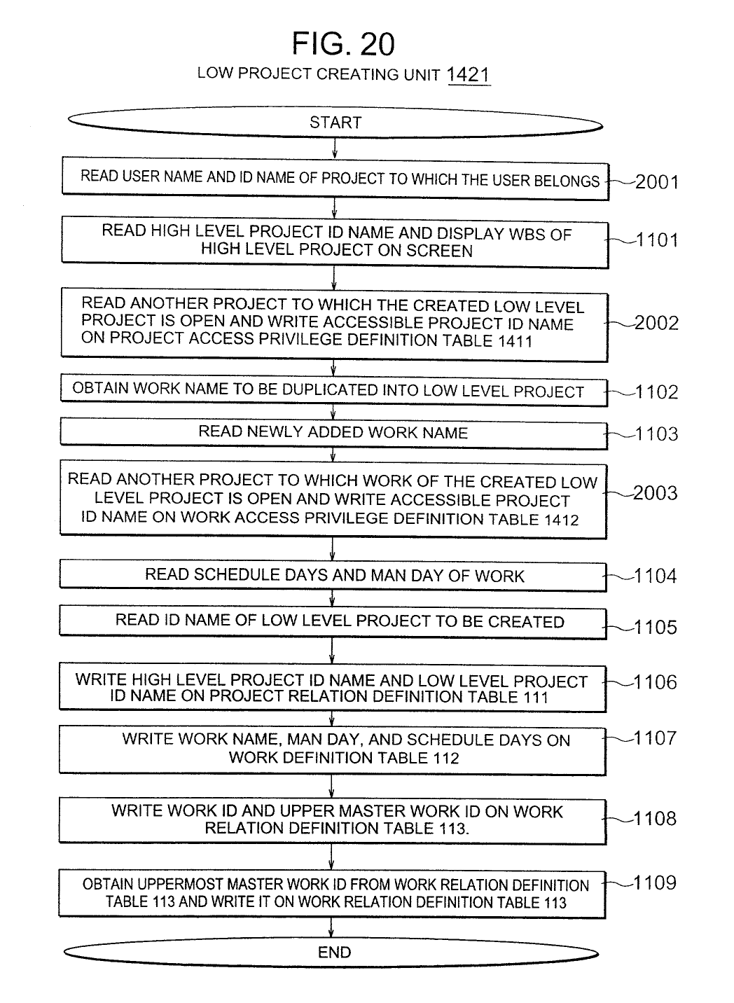

FIG. 20 is a flowchart showing a procedure of the low level project creating unit 1421 of this embodiment. The difference of the low level project creating unit 1421 of this embodiment from the creating unit 121 of the first embodiment shown in the flowchart of FIG. 11 is only the processes of the steps 2001 to 2003 in which defined is which of the projects allows its user to access the project and the work.

At a step 2001, the low level project creating unit 1421 is served to read the ID name of the project to which the user belongs. In this embodiment, when the system is started, the user enters the ID name of the project of which the user is in charge, such as the “A product”.

The user additionally enters the project that allows its user to access the low level project to be created and its work. In the example of FIG. 18, by clicking the check box 1806, the user allows the users belonging to the projects “A product” and “A-library part” to access the low level project to be created. Further, the user allows only the user belonging to the project “A product” to access the work “debug”. Moreover, the user belonging to the project “A-screen part” can access all works of the project “A-screen part”.

After entering the other setting items, like the first embodiment, the user clicks the “project creation” button. At a step 2002, the low level project creating unit 1421 is served to read the settings of the low level project entered by the user on the main storage unit. Unlike the first embodiment, the second embodiment reads another project that allows its member to be open to the low level project to be created and then writes the accessible project ID name on the project access privilege definition table 1411. Further, the “A product” project ID name and each accessible project ID name of “A product”, “A-library product” and “A-screen part” are written on the row 1503.

At a step 2003, the operation is executed to read another project that allows its members to be open to the work of the low level project to be created and to write the accessible project ID name on the work access privilege definition table 1412.

(3) Display of Project

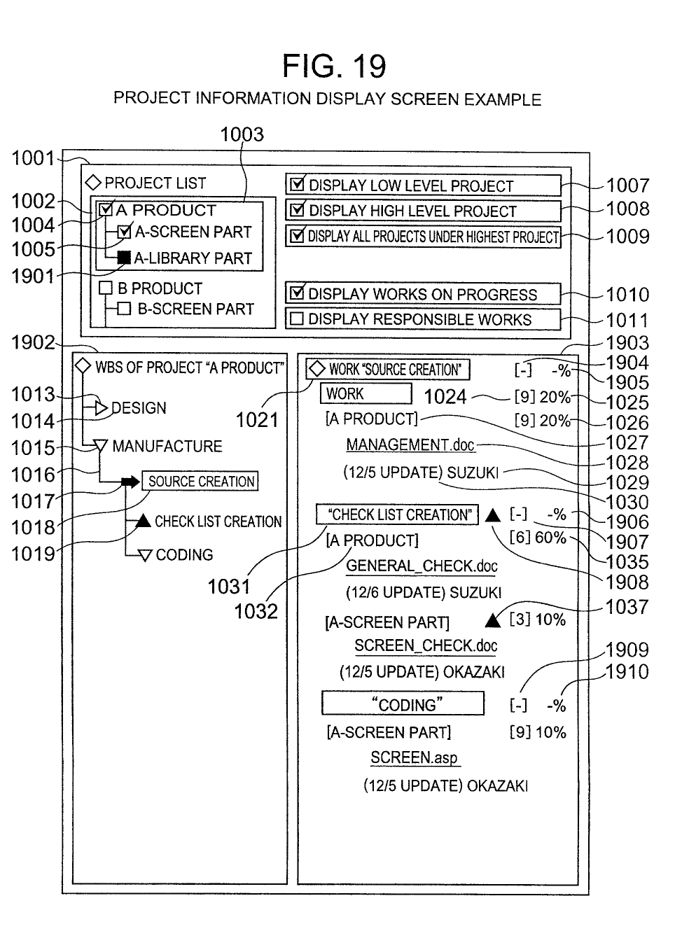

FIG. 19 illustrates an example of a project information display screen of this embodiment.

Only the difference of the process of displaying the project between the first embodiment and the second embodiment will be described below.

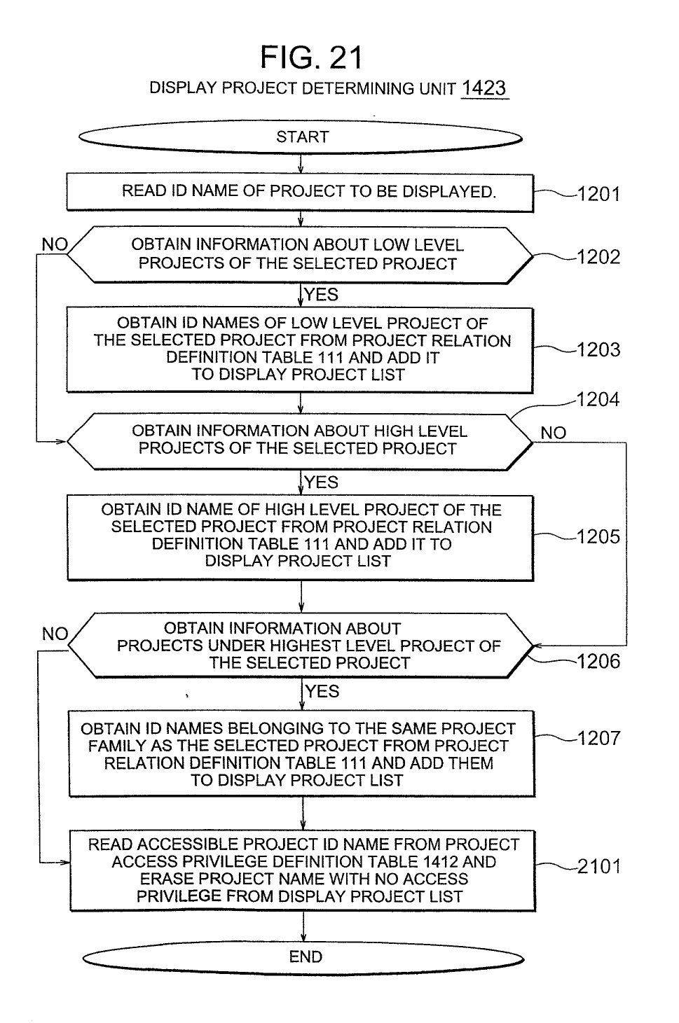

FIG. 21 is a flowchart showing a procedure of the display project determining unit 1423 included in this embodiment. The difference between the display project determining unit 123 (see FIG. 12) of the first embodiment from that 1423 of the second embodiment is only the addition of a step 2101. At the step 2101, the operation is executed to obtain the list of the projects to be accessed by the user from the project access privilege definition table 1411 and to erase an ID name of a project with no access privilege from the list of the display project ID names. In this embodiment, the ID name of the “A-library part” project is erased from the list and the “A product” and the “A-screen part” are stored in the list of the display project ID names.

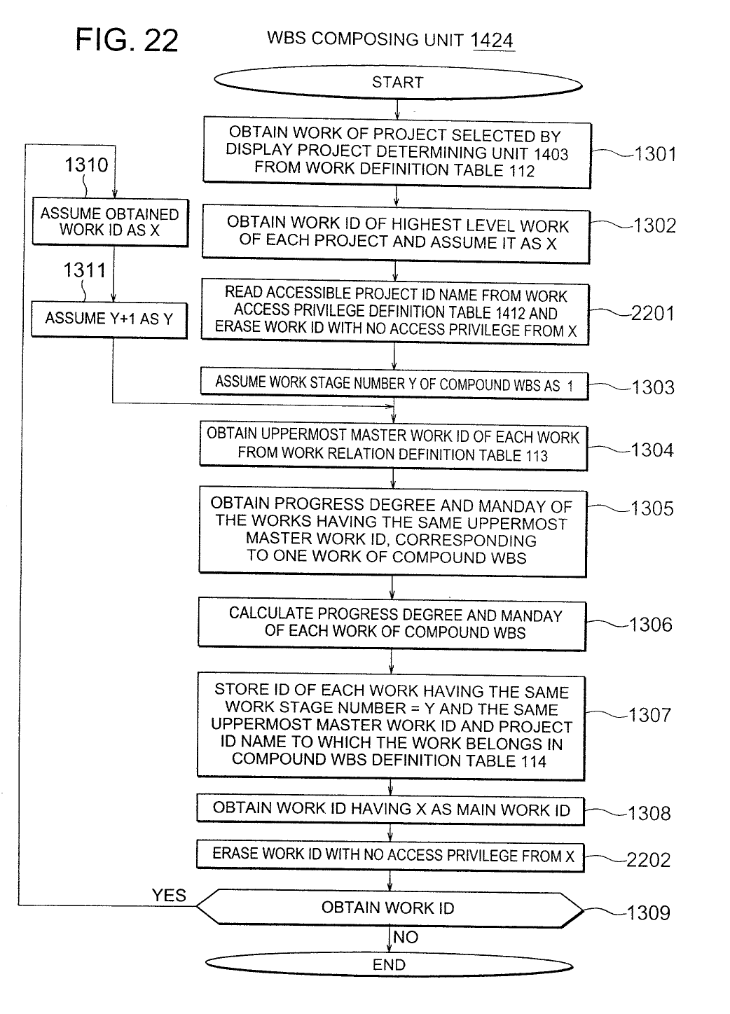

FIG. 22 is a flowchart showing a procedure of the WBS composing unit 1424 of this embodiment. The difference of the WBS composing unit 1424 between the first and the second embodiments is only the steps 2201 and 2202 at which the work with no access privilege given to the user is excluded from the list of the project to be displayed.

At the steps 1301 and 1302, after obtaining the work information of each project to be displayed and the work ID of the highest level work, at the step 2201, the operation is executed to read an accessible project ID name from the work access privilege definition table 1412 and to erase the ID of the work not to be accessed by the user from X (work ID list) (step 2201). In this example, the work ID “1” of the “design” is erased. Further, after creating the compound WBS definition table 114, at the step 2202, the operation is executed to erase the work ID of the work with no access privilege from X.

Next, like the first embodiment, the WBS filtering unit 125 is served to erase the record that is not matched to the condition from the compound WBS definition table 114.

The next registering document information composing unit 1425 is served to access the document access privilege definition table 1413 that is added in this embodiment.

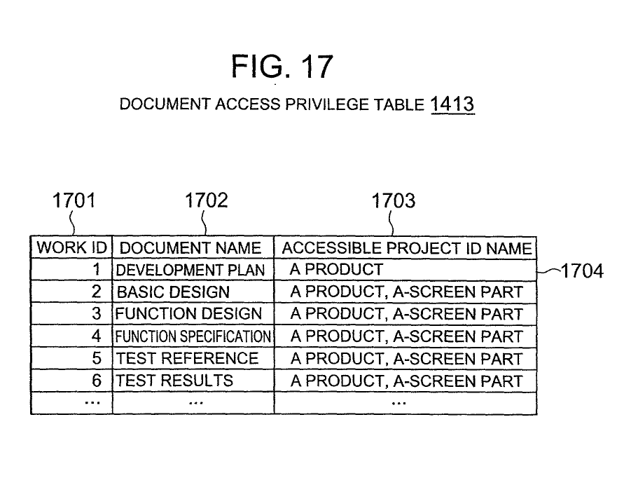

FIG. 17 illustrates an example of the document access privilege definition table 1413 of this embodiment. In FIG. 17, a numeral 1701 denotes an ID of the work in which the document is registered. A numeral 1702 denotes a document name. A numeral 1703 denotes an ID name of a project to which the user who can access the document belongs. One row composed of the columns 1701 to 1703 forms a record that defines a project that allows its members to access a certain work. The row 1704 represents the case that only the user belonging to the “A product” project can access a development plan document registered in the work with a value of 1 as its work ID.

This table is created in advance or when the document is registered.

In turn, the description will be oriented to the registered document information composing unit 1425. Like the registered document information composing unit 126, after obtaining the document name, the location and the registration date from the document registration table 115, the accessible project ID name 1703 is obtained from the document access privilege definition table, delete a record with no access privilege given to the user, and store it in the compound WBS document definition table 116.

Then, like the first embodiment, the document registering status transmitting unit 127 is served to transmit the compound WBS and its document registration information document to the output unit 103. On the output unit 103 is displayed the compound WBS and its document registration information document. This is the end of the process of the document registering status displaying unit 1422.

3. Modifications

In this embodiment, the low level project creating unit for defining the low level project is provided independently in the process of defining the project. However, the low level project creating unit may be integrated with the software for defining the work structure and the highest level project.

Moreover, in this embodiment, the report on progress of the project, the registration of the document and the definition of the document access privilege are executed in the different process from the definition or the display of the project. The embodiment may be modified so that these works may be executed on the project information display screen shown in FIG. 10. In this case, the buttons of “registration” and “update” are added on the Window 1020 for displaying the details of the work so that the interface for data entry may be provided to the user.

In a case that the foregoing project information displaying unit includes the registering and updating works of various kinds of tables and that the user changes the privilege as described in the second embodiment, the identification and the authentication of the “user” are the important factors. The program may be executed to identify and authenticate the user at the outset of the process. For identifying and authenticating the user are used the well-known individual ID and password or individual ID and biometrics. Only if the user is the authorized person, the embodiment may be modified so that the subsequent process may be executed.

In the second embodiment, if the project or the work with no access privilege is specified by the user, a warning message may be displayed on screen for warning the user of no access privilege.

It will be further understood by those skilled in the art that the foregoing description has been made on embodiments of the invention and that various changes and modifications may be made in the invention without departing from the spirit of the invention and scope the appended claims.

What is claimed is:

1. A method of managing a hierarchically structured project on a computer, comprising the steps of:
defining subprojects composing the hierarchical structure;
defining each structure of works composing said subproject;
storing information about each work of said subproject;
collecting information of the corresponding works among the plurality of subprojects selected by a user as a compound work; and
displaying the information of said works on a compound-work basis.

2. A project management method as claimed in claim 1, wherein the information about said each work includes progress information and the method displays a progress degree of all works composed as said compound work.

3. A project management method as claimed in claim 1, wherein an access privilege is set to said project, said subproject and said work, and the informations of said project, said subproject and said work, the access privileges of which are given to the user, are displayed.

4. A method of displaying information of a hierarchically structured project composed of a plurality of subprojects, each of said subprojects being composed of a plurality of works, comprising the steps of:
displaying a hierarchical structure of each project;
specifying the subprojects selected by a user;
reading information about the works of said specified subprojects from a table;
specifying a corresponding relation of works among said specified subprojects, and collecting the related works as a compound work;
displaying the read information about the works on the compound-work basis.

5. A project display method as claimed in claim 4, wherein the information about said each work includes progress information and the method displays a progress degree of all works composed as said compound work.

6. A project display method as claimed in claim 5, wherein the progress state including a delay of each compound work and each work is displayed by using a mark.

7. A project display method as claimed in claim 4, wherein the information about said each work includes a storage location of a document of each work and the content of the document is displayed in response to the indication of the user.

8. A project display method as claimed in claim 7, wherein an access privilege is set to said project, said subproject, said work and said document in advance, and only the informations about said project, said subproject, said work and said document, the access privileges of which are given to the user, are displayed.

9. A system of managing a hierarchically structured project, comprising:
project defining means for defining subprojects composing the hierarchical structure;
WBS (Work Breakdown Structure) defining means for defining each structure of works composing said subproject;
storage means for storing information about each work of said subproject;
compound work generating means for collecting information about the corresponding works among the plurality of subprojects selected by the user as a compound work; and
display means for displaying information about said works on the compound-work basis.

10. A program of displaying information of a hierarchically structure project composed of a plurality of subprojects, each of said subprojects being composed of a plurality of works, comprising codes for executing the following steps of:
displaying a hierarchical structure of each project;
specifying the subprojects selected by the user;
reading the information about the works of said specified subproject from a table;
specifying a corresponding relation of said works among said specified subprojects and collecting the related works as a compound work; and
displaying the read information about said work on the compound-work basis.
